(19) United States
(12) Patent Application Publication
(10) Pub. No.: US 2025/0039056 A1
(43) Pub. Date: Jan. 30, 2025

(54) REGULATING USAGES OF RESOURCES SHARED BY MICROSERVICE CONSUMERS BASED ON CAPACITY AND CONSUMPTION QUOTAS

(71) Applicant: HEWLETT PACKARD ENTERPRISE DEVELOPMENT LP, Spring, TX (US)

(72) Inventors: Satyendra Singh, Bangalore (IN); Sanjaya Kumar Sahoo, Bangalore (IN); Tathagata Roy, Bangalore (IN)

(21) Appl. No.: 18/358,144

(22) Filed: Jul. 25, 2023

(51) Int. Cl. H04L 41/0894

(52) U.S. Cl. CPC H04L 41/0894

(57) ABSTRACT

A process includes receiving, by a first proxy for a first microservice consumer of a plurality of microservice consumers, a first request from the first microservice consumer associated with a usage of a resource. The resource is shared by the plurality of microservice consumers. The process includes allowing, by the first proxy, the first request responsive to a cumulative usage of the resource by the first microservice consumer complying with a predefined consumption quota for the first microservice consumer; and responsive to allowance of the first request, receiving, by a second proxy for the resource, a second request associated with the usage. The process includes responsive to the second request, controlling, by the second proxy, whether the usage is permitted responsive to a predefined capacity quota for the resource.

### BACKGROUND

In one type of application architecture, an application may be monolithic and correspond to a single unit. In another type of application architecture, an application may be formed from multiple, autonomous parts called “microservices.” As compared to the monolithic architecture, the microservice architecture provides greater agility, elasticity and control for software quality assurance.

### BRIEF DESCRIPTION OF THE DRAWINGS

FIG. 1 is a block diagram of a computer system according to an example implementation having a microservice architecture that regulates microservice usage of a shared resource by enforcing policy-specified consumption and resource quotas.

FIG. 2 is an illustration of the use of container pod-located network traffic control edge (TCE) proxies to regulate microservice usage of a shared resource according to an example implementation.

FIG. 3 is a block diagram of a microservice architecture that includes a TCE proxy and a network policy enforcer according to an example implementation.

FIG. 4 is a sequence diagram depicting communications and actions to create resource and consumer policies according to an example implementation.

FIG. 5 is a sequence diagram depicting communications and actions to control network traffic flows based on resource and consumer policies according to an example implementation.

FIG. 6 is a flow diagram depicting handling of a policy breach according to an example implementation.

FIG. 7 is a flow diagram depicting a process to control usage of a shared resource by a microservice consumer based on consumption and capacity quotas according to an example implementation.

FIG. 8 is a block diagram of a system that includes microservice pods and a shared resource pod, which regulate usage of a shared resource based on consumption and capacity quotas according to an example implementation.

FIG. 9 is an illustration of machine-readable instructions that, when executed by a machine, cause the machine to selectively permit a request by a microservice consumer to use a resource based on transport layer traffic associated with the microservice consumer and a policy defining a consumption quota for the microservice, according to an example implementation.

### DETAILED DESCRIPTION

The following detailed description refers to the accompanying drawings. Wherever possible, the same reference numbers are used in the drawings and the following description to refer to the same or similar parts. It is to be expressly understood, however, that the drawings are for the purpose of illustration and description only. While several examples are described in this document, modifications, adaptations, and other implementations are possible. Accordingly, the following detailed description does not limit the disclosed examples. Instead, the proper scope of the disclosed examples may be defined by the appended claims.

The terminology that is used herein is for the purpose of describing particular examples only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “connected,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

A computer system may include a set of microservices (herein called “microservice consumers”) that share a particular resource (herein called a “shared resource”). In an example, a shared resource may be a database. In another example, a shared resource may be a message broker. In another example, a shared resource may be an application programming interface (API). In the context used herein, consuming a shared resource refers to the resource providing data or receiving data.

Due to a shared resource having finite capacities, a set of microservice consumers may potentially overutilize the shared resource. In this manner, the set of microservice consumers may concurrently request more output from the shared resource than the shared resource can provide or concurrently provide more input to the shared resource than the shared resource can receive or process. Such overutilization may lead to partial or full computer system unavailability.

In one approach to avoid shared resource overutilization, microservice consumers may individually adjust their respective consumptions. For example, the number of web page requests sent by respective microservice consumers to a shared resource may be limited to a number just below the capacity of the shared resource. As another example, the number of hypertext transfer protocol (HTTP) requests sent by respective microservice consumers to a shared resource may be limited to a number just below the capacity of the shared resource. However, such an approach does not consider the overall capacity of the shared resource and may be rather ineffective at preventing resource overutilization.

In accordance with example implementations that are described herein, a microservice architecture regulates usage of a shared resource by a set of microservice consumers by enforcing microservice consumer compliance with microservice consumption quotas and enforcing resource consumption compliance with resource capacity quotas. Among the potential advantages, resource overutilization may be prevented, while resource availability fairness for the microservice consumers may be promoted.

In accordance with example implementations, capacity quotas for a particular shared resource may be specified by one or multiple resource polices. In this context, a “resource policy” is a set of data (e.g., data contained in a file), which defines one or multiple criteria (e.g., one or multiple capacity quotas) from the perspective of a resource for regulating consumption of the resource. A resource policy may be viewed as one type, or category, of an agreement policy to govern shared resource usage. A resource policy may conform to a particular form, or template.

In an example, a particular capacity quota may correspond to an actual maximum capacity of the resource. The actual maximum capacity may be potentially be reached by one microservice consumer or reached by multiple microservice consumers that concurrently interact with the shared resource. In an example of a capacity quota, a shared resource may be capable of providing a total outgoing, or egress, network traffic flow up to 20 Megabits per second (Mb/s). In another example of a capacity quota, a shared resource may be capable of receiving a total ingoing, or ingress, network traffic flow of up to 10 Mb/s. The foregoing capacity quotas are examples of L4 network telemetry-related quotas. Here, “L4” refers to layer four (L4) (or the “transport layer”) of the Open Systems Interconnection (OSI) model.

Capacity quotas for a shared resource may be specified for different respective time frames. For example, a shared resource may be capable of providing a total egress network traffic flow up to 20 Mb/s, and the shared resource may be capable of providing a total egress network traffic flow of up to 2 Gigabits per hour (Gb/h). In a similar manner, ingress capacity quotas for a shared resource may be specified for different time frames. For example, a shared resource may be capable of receiving a total ingress network traffic flow up to 10 Mb/s, and the shared resource may be capable of receiving a total ingress network traffic flow of up to 1 Gb/h.

A capacity quota for a shared resource may be specified in terms of an L4 network telemetry metric other than a time rate of the network traffic. For example, a capacity quota for a shared resource may be the maximum number of concurrent network connections (e.g., transport control protocol (TCP) connections) that can be handled by the shared resource in a unit of time. In an example, a capacity quota for a shared resource may be 100 concurrent network connections per minute. In another example, a capacity quota for a shared resource may be a maximum number of open network connections (e.g., 1000 maximum open TCP connections) that the shared resource can handle. Moreover, different capacity quotas may be specified for network connections for different time frames.

A capacity quota for a shared resource may be specified in terms of a network telemetry metric that is associated with a network layer other than L4. For example, a capacity quota for a shared resource may be in terms of an L7 metric, where “L7” refers to layer seven, or the application layer of the OSI model. In an example, a capacity quota for a shared resource may be the maximum number of ingress web page requests that can be received by the shared resource in a certain time period. In another example, a capacity quota for a shared resource may be the maximum number of hypertext transfer protocol (HTTP) requests that can be received by the shared resource in a certain time period.

A capacity quota for a shared resource may be a limit that is less than the actual corresponding maximum capacity of the shared resource. For example, although the maximum ingress network traffic flow rate for a shared resource may be 12 MB/s, the corresponding capacity quota may be set to 10 MB/s.

In accordance with example implementations, consumption quotas for a particular microservice consumer may be specified by one or multiple consumer policies. In this context, a “consumer policy” is a set of data (e.g., data contained in a file), which defines one or multiple criteria (e.g., one or multiple consumption quotas) from the perspective of a microservice consumer for regulating shared resource consumption by the microservice consumer. A consumer policy may conform to a particular form, or template. A consumer policy may be viewed as being one type of agreement policy to control consumption of a shared resource.

In an example, an assumption may be made that all of a microservice consumer's network activities result in shared resource consumption, and all of the microservice consumer's network activities are regulated based on a corresponding set of consumption quotas. In another example, consumption quotas may be applied to specific network activities of a microservice consumer, such as activities in which a microservice will directly access a shared resource or activities that will result in another microservice directly accessing a shared resource. The consumption quotas for a set of microservice consumers that shared a particular resource may be set, or allocated, in a manner that promotes consumption fairness among the microservice consumers.

As examples, a consumption quota may specify an egress network traffic flow rate or an ingress network traffic flow rate. The consumption quota may be in terms of network telemetry metric, such as an L4 or L7 metric. For example, a consumption quota for egress network traffic for a particular microservice consumer may be 2 Mb/s. In another example, a consumption quota for ingress network traffic for a particular microservice consumer may be 1 Mb/s. As other examples, a consumption quota may specify a number of maximum open TCP connections irrespective of time or a number of concurrent TCP connections per minute. In other examples, a consumption may specify a number of egress web page requests per minute or a number of egress HTTP requests per minute for a microservice consumer. Moreover, consumption quotas for the same microservice consumer may specify different respective time frames for the same network metric (e.g., an ingress network traffic rate quota of 80 Mb/h and another ingress network traffic rate quota of 2 Mb/s).

In accordance with example implementations that are described herein, the usage or consumption of a shared resource by a set of microservice consumers is regulated using network traffic-intercepting edge proxies. More specifically, in accordance with example implementations, the microservice architecture includes an edge proxy for the shared resource and edge proxies for respective microservice consumers. In this context, an “edge proxy” generally refers to an agent for a principal (e.g., a shared resource or a microservice consumer) that is disposed in a location to control network traffic communication with the principal. In general, the edge proxy serves as a network traffic gatekeeper. As such, the edge proxy is referred to as a “traffic controller edge (TCE) proxy” herein. For the microservice consumer, the TCE proxy is also referred to as a “microservice consumer TCE proxy” herein. For the shared resource, the TCE proxy is also referred to as a “shared resource TCE proxy” herein.

In accordance with example implementations, a microservice consumer may be formed by one or multiple containers of a group, or pod, of containers (herein called the “microservice consumer pod”). The pod includes one or multiple containers that provide the microservice consumer. The pod includes a central, or main, container through which all network traffic for the microservice consumer passes. In accordance with example implementations, a microservice consumer TCE proxy intercepts all ingress network requests to the main container, and the microservice consumer TCE proxy intercepts all egress network requests that are provided by the main container. In accordance with example implementations, the interception of network requests may be an L4 interception of network packets. The TCE proxy selectively controls whether network requests are allowed (and pass through the TCE proxy) or whether the network requests are denied (or do not pass through the TCE proxy).

In this manner, for an ingress network request, the microservice TCE proxy intercepts the request, determines (using a network policy enforcer, as further described herein) whether the applicable consumer policy(ies) allow the request, and if the ingress network request is allowed, the microservice consumer TCE proxy passes the request on to the main container for processing. Otherwise, the microservice consumer TCE proxy rejects, or denies, the ingress request, and accordingly, the main container does not receive or process the request.

For an egress network request that is provided by the main container, the microservice consumer TCE proxy intercepts the request, determines (using a network policy enforcer, as further described herein) whether the applicable consumer policy(ies) allow the request, and if the egress network request is allowed, the microservice consumer TCE proxy passes the request on to the intended recipient (e.g., a shared resource or another microservice consumer). Otherwise, the microservice consumer TCE proxy rejects, or denies, the egress request, and accordingly, the recipient does not receive the request.

As further described herein, in accordance with some implementations, the microservice architecture includes a network policy enforcer that is associated with the microservice consumer TCE proxy. The microservice consumer TCE proxy uses the network policy enforcer to, for a given request, check the consumption policy(ies) for purposes of determining whether or not a policy breach has occurred. For this purpose, in accordance with example implementations, the network policy enforcer identifies one or multiple relevant, or applicable, cumulative usages and determines whether any of the cumulative usages exceeds (or “violates”) a corresponding consumption quota. In accordance with example implementations, if a cumulative usage violates a consumption quota, then a breach of the corresponding consumption policy has occurred.

In the context used herein, a “cumulative usage” (which may also be referred to as a “cumulative usage of the shared resource”) refers to a measure of an aggregate consumption of the shared resource by the microservice. In an example, a cumulative usage may be a time rate of egress data (e.g., a number of bits per second or a number of bits per hour) that has passed through the microservice TCE proxy. For example, an egress cumulative usage may be a count of bits of egress data, which have passed through the TCE proxy during a trailing time window (e.g., a window corresponding to the last minute or a window corresponding to the last hour). In another example, an ingress cumulative usage be a time rate of ingress data that has passed through the microservice TCE proxy. For example, the network policy enforcer may consider a count of bits of ingress data, which have passed through the TCE proxy during a trailing time window. In another example, a cumulative usage may be a count of the concurrent TCP connections for the main container. In another example, a cumulative usage may be a count of open TCP connections for the main container during a trailing time window.

As an example, for an ingress network request, the microservice consumer TCE proxy may request that the network policy enforcer check ingress cumulative usages against corresponding ingress consumption quotas. In accordance with example, implementations, if the none of the ingress consumption quotas are violated (i.e., no policy breach has occurred), the network policy enforcer sends an approval to the microservice consumer TCE proxy, and the microservice consumer TCE proxy allows the ingress network request, and otherwise, the microservice consumer TCE proxy denies the ingress network request. In another example, for an egress network request, the microservice consumer TCE proxy may request that the network policy enforcer check egress cumulative usages against corresponding egress consumption quotas. In accordance with example, implementations, if the none of the egress consumption quotas are violated, the network policy enforcer sends an approval to the microservice consumer TCE proxy, and the microservice consumer TCE proxy allows the egress network request, and otherwise, the microservice consumer TCE proxy denies the egress network request.

The network policy enforcer, in accordance with example implementations, may be external to, or separate from, the microservice consumer pod. A particular advantage of the network policy enforcer being separate from the microservice consumer pod is that any policy changes, deletions or modifications may be instantiated without restarting any container (e.g., the TCE proxy or the main container) of the microservice consumer pod. Another advantage of the network policy enforcer being separate from the microservice consumer pod is that any policy changes, deletions or modifications may be instantiated without any modification of program code (e.g., program code of the TCE proxy or program code of the main container) of the microservice consumer pod. Another advantage of the network policy enforcer being separate from the microservice consumer pod is that any policy changes, deletions or modifications may be instantiated without changing or updating any configuration (e.g., a configuration of the TCE proxy or a configuration of the main container) of the microservice consumer pod. Another advantage of the network policy enforcer being separate from the microservice consumer pod is that any policy changes, deletions or modifications may be instantiated without incurring any microservice down time.

The microservice consumer TCE proxy, in accordance with example implementations, may be a sidecar pattern container of the microservice consumer pod. The sidecar pattern container, in general, shares resources (e.g., the same volume and the same network resources) with the main container. The sidecar pattern container is separate from the container(s) of the microservice consumer pod, which contain the microservice program code. Accordingly, among its potential advantages, the sidecar pattern container may be included in the microservice consumer pod and used to regulate network traffic communicated by and to the main container without any microservice program code being modified to implement the sidecar pattern container.

In accordance with example implementations, a network request may not be denied merely because a determination is made that a policy breach has occurred. In this manner, in accordance with some implementations, whether or not a policy breach is tantamount to a request denial may depend on whether a corresponding violated consumption quota is treated as a hard limit or a soft limit. In accordance with example implementations, the network policy enforcer treats a consumption quota as a “hard limit” by strictly enforcing the corresponding consumption quota, such that network requests are denied if the consumption quota is met or exceeded. In accordance with example implementations, a “soft limit” refers to the network policy enforcer handling a consumption quota violation in a way that allows a tolerance or deviation from the consumption quota, such that network requests are allowed as long as the applicable cumulative usage remains within the consumption quota, as modified by the tolerance or deviation.

In an example of a soft limit, the network enforcer may approve a network request even though a consumption quota is violated (and therefore, a policy breach occurs), as long as the request is fulfilled within a predefined amount of time. For example, a particular consumption quota for ingress network traffic may be 5 MB/s, and the network enforcer may apply a soft limit deviation that allows an ingress request to pass through the TCE proxy when the consumption quota is violated, as long as the request is completed within a time that is commensurate with a certain number of bus cycles. In another example, the network enforcer may apply a soft limit deviation that accommodates a consumption quota being exceeded by a predefined magnitude-based, or value-based deviation. For example, a consumption quota may limit the number of open TCP connections to be 30, but the network policy enforcer may approve a request as long as the actual number open TCP connections are within a ten percent variance (e.g., 33 open TCP connections) within a certain amount of time (e.g., 1 minute).

A particular consumer policy may, in accordance with example implementations, designate which consumption quotas (if any) are to be treated as soft limits, with the other limits being considered hard limits by default. Moreover, in accordance with example implementations, a particular consumer policy may set forth one or multiple criteria (e.g., magnitude variations, time restrictions, and other criteria) defining how a particular soft limit is to be handled.

In accordance with example, implementations a shared resource may be formed by one or multiple containers of a group, or pod, of containers (herein called the “shared resource pod”). The shared resource pod includes one or multiple containers that provide a resource, including a central, or main, container through which all network communication for the resource passes. In accordance with example implementations, a shared resource TCE proxy intercepts all ingress network requests to the main container and intercepts all egress network requests that are provided by the main container.

The shared resource TCE proxy applies the resource policy(ies) associated with the resource for purposes of controlling whether the intercepted requests are allowed or denied. In this manner, for an ingress network request, the shared resource TCE proxy intercepts the request and determines (as described herein), based on the ingress capacity quota(s) and applicable ingress cumulative usage(s), whether the ingress network request is allowed to pass through the TCE proxy. If the resource policy(ies) allow the ingress network request, then the shared resource TCE proxy passes the ingress network request on to the main container for processing. Otherwise, the shared resource TCE proxy rejects, or denies, the ingress network request, and accordingly, the main container does not receive the request. For an egress network request that is provided by the main container, the shared resource TCE proxy intercepts the egress network request, determines, based on the egress capacity quota(s) and the applicable cumulative usage(s), whether the egress network is allowed to pass through the TCE proxy. If so, then the shared resource TCE proxy passes the egress network request on to the intended recipient (e.g., a microservice consumer). Otherwise, the shared resource TCE proxy rejects, or denies, the egress request, and accordingly, the recipient does not receive the request.

As further described herein, in accordance with some implementations, the microservice architecture includes a network policy enforcer for the shared resource TCE proxy. The shared resource TCE proxy uses the network policy enforcer to, for a particular network request, check the applicable capacity quotas in view of the applicable cumulative usages for purposes of determining whether or not the request should be allowed to pass through the shared resource TCE proxy. The network policy enforcer may be external to the shared resource pod. A particular advantage of the network policy enforcer being separate from the shared resource pod is that any policy additions, deletions or modifications may be instantiated without restarting any container (e.g., the shared resource TCE proxy or the main container) of the pod. Another advantage of the network policy enforcer being separate from the shared resource pod is that any policy additions, deletions or modifications may be instantiated without modifying any program code (e.g., program code of the shared resource TCE proxy or program code of the main container) of the pod. Another advantage of the network policy enforcer being separate from the shared resource pod is that any policy additions, deletions or modifications may be instantiated without changing or updating any configuration (e.g., a configuration of the shared resource TCE proxy or a configuration of the main container) of the pod. Another advantage of the network policy enforcer being separate from the shared resource pod is that any policy additions, deletions or modifications may be instantiated without incurring any shared resource down time.

The shared resource TCE proxy, in accordance with example implementations, may be a sidecar pattern container of the shared resource pod. The sidecar pattern container, in general, shares resources (e.g., the same volume and the same network resources) with the main container of the shared resource pod. The sidecar pattern container is separate from the container(s) of the shared resource pod, which contain the shared resource program code. Accordingly, among its potential advantages, the inclusion of the sidecar pattern container in the shared resource pod may not involve modification of any shared resource program code.

In accordance with example implementations, whether or not a particular capacity quota violation results in a request denial may depend on whether the network policy enforcer for the shared resource TCE proxy treats the capacity quota as being a hard limit or a soft limit. A particular resource policy may, in accordance with example implementations, designate which capacity quotas (if any) are to be treated as soft limits. Moreover, in accordance with example implementations, a particular resource policy may set forth one or multiple criteria (e.g., magnitude variations, time restrictions, and other criteria) defining how a particular soft limit is to be handled.

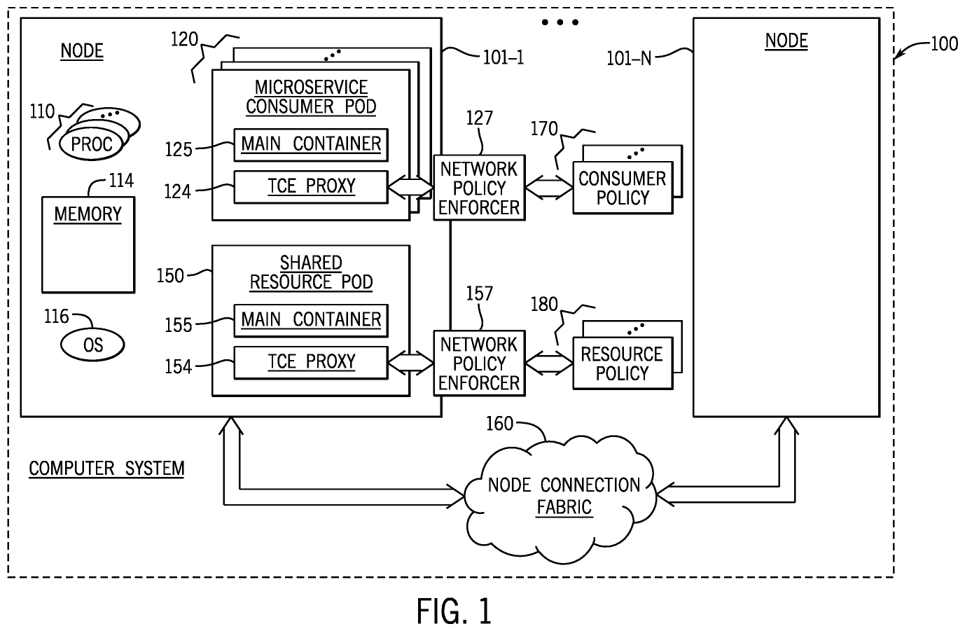

FIG. 1 depicts a computer system 100 in accordance with example implementations. Referring to FIG. 1, the computer system 100 may have one or multiple nodes 101 (N nodes 101-1 to 100-N being depicted in FIG. 1) that are coupled together via connection fabric 160. In an example, a node 101 may be a computer platform. In this context, a “computer platform” is a processor-based electronic device, which has actual, or physical, hardware and actual machine-readable instructions (or “software”).

As examples, a computer platform may be an Internet-of-Things (IoT) device, a standalone server, a rack-mounted server module; an edge processing, rack-mounted module; a server blade; a blade enclosure containing one or multiple server blades; a client; a thin client; a desktop computer; a portable computer; a laptop computer; a notebook computer; a tablet computer; network device, a network switch, a gateway device, a smartphone; a wearable computer; or other platform.

In another example, a node 101 may be an abstraction of hardware and software. In an example, a node 101 may be a virtual machine. In this context, a virtual machine refers to a virtual environment that functions as a machine level abstraction, or virtual computer system, which has its own physical resources (e.g., CPU(s), system memory, network interface(s) and storage). Moreover, the virtual may have its own abstraction of an operating system; and in general, the virtual machine is a virtual abstraction of hardware and software resources of a computer platform. In another example, a node 101 may be a host instance, which is a logical instance of a computer platform.

The connection fabric 160 may include any of a number of different communication interconnects. In an example, the connection fabric 160 may include one or more physical buses (e.g., a Peripheral Component Interconnect express (PCIe) bus, a system bus, a Compute eXpress Link (CXL) bus or other communication link) or messaging buses. In another example, the connection fabric 160 may include a rack backplane. In another example, the connection fabric 160 may include network fabric. For example, the network fabric may be associated with one or multiple types of communication networks, such as Fibre Channel networks, CXL fabric, dedicated management networks, local area networks (LANs), wide area networks (WANs), global networks (e.g., the Internet), wireless networks, or any combination thereof. In an example, the connection fabric 160 may include a physical interconnect infrastructure. In another example, the connection fabric 160 may be a virtual abstraction of a physical interconnect infrastructure.

Regardless of the particular architecture of the node 101 and whether or not the node 101 is virtual or physical, the node 101 has associated actual hardware and software. In this manner, the hardware may include one or multiple hardware processors 110 (e.g., one or multiple central processing units (CPUs), one or multiple CPU processing cores, one or multiple graphics processing units (GPUs), one or multiple GPU processing cores, and other hardware processors); and a system memory 114.

The system memory 114 is a non-transitory storage media that may be formed from semiconductor storage devices, memristor-based storage devices, magnetic storage devices, phase change memory devices, a combination of devices of one or more of these storage technologies, and so forth. The system memory 114 may represent a collection of memories of both volatile memory devices and non-volatile memory devices.

The system memory 114 may store machine-readable instructions that are executed by the processors 110 to form various software components of the computer platform 100. In an example, one or multiple hardware processors 110 may execute the instructions to form an operating system 116. In examples, the operating system 116 may include any or some combination of the following: a Linux operating system, a Microsoft Windows operating system, a Mac operating system, a FreeBSD operating system, or other operating system.

One or multiple hardware processors 110 may execute instructions to form one or multiple microservice consumer pods 120 (or “microservice consumer pod instances”) and one or multiple shared resource pods 150 (or “shared resource pod instances”). The microservice consumer pod 120 is a group of containers that provide a particular microservice. In the context used herein, a “microservice” refers to an instance of a subpart of an application that includes multiple subparts. In an example, a microservice may correspond to a particular function or a particular related set of functions of an application.

In an example, a set of microservices may correspond to an e-commerce application. In this manner, one microservice may provide a user interface, another microservice may provide user shopping cart functions, another microservice may provide shipping-related functions, another microservice may manage product lookup, another microservice may provide customer service functions, another microservice may provide product recommendations, and so forth. A set of microservices may be associated with an application other than an e-commerce application (e.g., web server applications, content streaming applications, inventory management applications, human resource management applications, fleet management applications and as well as other applications that benefit from the microservice model), in accordance with further implementations.

The containers of the microservice consumer pod 120 may share one or multiple resources. In an example, the containers of a microservice consumer pod 120 may share the same network namespace. In an example, the containers of a microservice consumer pod 120 may share one or multiple logical storage volumes.

A microservice consumer pod 120 may include a primary, or main, container 125, which corresponds to the program code, which is executed to provide the function(s) of the corresponding microservice. Moreover, in accordance with example implementations, all egress network traffic for the microservice passes through the main container 125, and all ingress network traffic for the microservice passes through the main container 125.

A microservice consumer pod 120 may further include one or multiple secondary containers that support the main container 125, such as a container, called a “microservice consumer TCE proxy 124,” or “TCE proxy 124” herein. The microservice consumer TCE proxy 124 serves as a network traffic gatekeeper to control, or regulate, the communication of network traffic with the main container 125 based on one or multiple consumer policies 170 that are associated with the microservice consumer pod 120. In this context, the TCE proxy's regulation of the communication of network traffic with the main container 125 includes the TCE proxy 124 controlling whether ingress network requests received by the TCE proxy 124 pass through to the main container 125 or whether the ingress network requests are denied. Moreover, in this context, the TCE proxy's regulation of the communication of network traffic with the main container 125 includes controlling whether egress network requests provided by the main container 125 are allowed to pass through to the recipient or whether the egress network requests are denied.

The consumer policy(ies) 170 define one or multiple consumption limits, or quotas, for a particular microservice consumer pod 120. In an example, a consumer policy 170 may be an ingress consumer policy that sets one or multiple quotas for ingress traffic that is received by the microservice service pod 120 and intercepted by the TCE proxy 124. In an example, an ingress consumer policy 170 may specify a quota on the maximum incoming network traffic flow rate for the microservice. The TCE proxy 124 observes real time or near real time metrics of network traffic that is received by the main container 125 for purposes of deriving corresponding cumulative usages by the microservice. The TCE proxy 124, in accordance with example implementations, allows ingress network requests to pass through to the main container 125 until a cumulative usage does not comply with a corresponding ingress consumption quota. As further described herein, whether or not a cumulative usage complies with a particular ingress consumption quota may depend on whether the consumption quota is treated as a soft limit or treated as a hard limit.

An ingress consumer policy 170 may specify multiple consumption quotas for the ingress network traffic flow rate, referenced to different time periods. For example, one consumption quota may be a maximum ingress network traffic flow per second, and another consumption quota may be a maximum ingress network traffic flow per hour. An ingress consumer policy 170 may contain one or multiple quotas other than limits on the rates of incoming network traffic. For example, an ingress consumer policy 170 may specify a quota on the time rate of concurrent connections (e.g., TCP connections) used to communicate ingress network traffic. Depending on the particular implementation, a particular microservice consumer pod 120 may have multiple ingress consumer policies 170 that each specify a different quota, or a particular microservice consumer pod 120 may have a single ingress consumer policy 170 that contains multiple ingress consumption quotas.

The consumer policies 170 for a particular microservice consumer pod 120 may include one or multiple egress consumer policies 170 that specifies consumption quotas for egress data that is sent by the main container 125. The TCE proxy 124 observes the real time or near real time metrics of egress data communicated from the main container 125 to derive corresponding cumulative usages, and the TCE proxy 124, in accordance with example implementations, allows egress network requests to pass to the recipients until a cumulative usage does not comply with an egress consumption quota. As described further herein, whether or not a cumulative usage complies with a particular egress consumption quota may depend on whether the egress consumption quota is treated as a soft limit or a hard limit.

In an example, a set of microservice consumer pods 120 may have different associated consumer policies 170. In another example, one or multiple microservice consumer pods 120 may have the same associated consumer policies 170.

A shared resource pod 150 is a group of containers that provide a resource that is shared by multiple microservice consumers (e.g., microservice consumers corresponding to a set of microservice consumer pods 120). In this context, a “resource” refers to a virtual or physical component (e.g., a storage unit or a processing unit) that has a finite capacity. In this manner, the resource may underperform or potentially cause a whole or partial computer system failure if the finite capacity of the resource is overutilized, or exceeded. A given resource may have one or multiple such capacities. In an example, a resource may have a maximum processing bandwidth that is tied to the amount of ingress data (e.g., a maximum amount of ingress data per second) that is received by the resource. In another example, a resource may be incapable of providing egress data that exceeds a certain threshold rate (e.g., a maximum amount of egress data per second). In another example, a resource may be unable to support more than a particular number of open network connections at one time. In another example, a resource may be unable to support more than a certain number of concurrent network connections per minute (or other time frame).

A message broker is an example of a resource that may be provided by a shared resource pod 150 and shared by multiple microservice consumers. In this context, a “message broker” generally refers to an entity that allows different entities (e.g., instances, services and systems) to communicate with each other. In general, a message broker may perform message validation, format transformations and routing of messages among different entities. In an example, the message broker may be a message queuing telemetry transport (MQTT) message broker, and the nodes 101 may correspond to computer platforms. Apache Kafka and RabbitMQ are other examples of message brokers.

In another example, a shared resource 150 may provide a database, which may be shared by multiple microservice consumers. In an example, for online commerce-related microservices, a database may, for example, store customer information, product information or sales records. An API is another example of a resource that may be provided by a shared resource pod 150 and which may be shared by multiple microservice consumers.

A shared resource pod 150 may include a primary, or main, container 155, which corresponds to the program code that is executed to provide the function(s) of the corresponding resource. A shared resource pod 150 may further include one or multiple secondary containers that support the main container 155, such as a container, called a “shared resource TCE proxy 154,” or “TCE proxy 154” herein. The TCE proxy 154 controls, or regulates, network traffic with the main container 155 based on one or multiple resource policies 180 that are associated with the shared resource pod 150. In an example, the TCE proxy 154 may be a sidecar pattern container that shares resources (e.g., shared network resources and storage resources) with the main container 155.

A resource policy 180 may specify one or multiple capacity quotas for the shared resource pod 150. A given capacity quota may or may not correspond to the actual capacity of the resource. The resource policies 180 may include one or multiple egress resource policies 180 that specify capacity-related quotas for egress network traffic that is sent by the main container 155. In examples, a capacity quota may be a time rate of network traffic that is sent by the main container 155 for a particular time frame, a time rate of concurrent network connections used by the main container 155 to send egress network traffic, or a total number of open network connections used by the main container 155 to send egress network traffic. A given capacity quota of a particular egress resource policy 180 may be treated as a hard quota or a soft quota, as further described herein. The TCE proxy 154 intercepts network requests that are sent by the main container 155, and in accordance with example implementations, the TCE proxy 154 allows network requests to be sent out from the shared resource pod 150 until an egress cumulative usage does not comply with a corresponding egress capacity quota.

The resource policies 180 may include one or multiple ingress resource policies 180 that specifies capacity-related quotas for ingress data that is received by the shared resource pod 150. In examples, an ingress capacity quota may be a time rate of the network traffic data that is received by the main container 155, a time rate of concurrent network connections used by the main container 155 to receive ingress network traffic, or a total number of open network connections used by the main container 155 to receive ingress network traffic. A given capacity quota of a particular ingress resource policy 180 may be treated as a hard quota or a soft quota, as further described herein. The TCE proxy 154 intercepts network traffic requests that are sent to the shared resource pod 150 such that that the intercepted requests reach the main container 155 if allowed by the TCE proxy 154. In accordance with example implementations, the TCE proxy 154 allows network ingress network requests to be received by the main container 155 until an ingress cumulative usage does not comply with a corresponding capacity quota.

In an example, the shared resource pod 150 may have an associated egress resource policy 180 and an associated ingress resource policy 180. In another example, the shared resource pod 150 may have a single resource policy 180 that sets forth ingress and egress capacity quotas. In another example, the shared resource pod 150 may have multiple egress resource policies 180 and multiple ingress resource policies 180.

In an example, a set of microservice consumer pods 120 that correspond to a set of microservices for a particular application may be disposed on single node 101. In another example, a set of microservice consumer pods 120 that correspond to a particular application may be distributed over multiple nodes 101. In an example, the shared resource pod 150 is disposed on the same node 101 as a corresponding set of microservice consumer pods 120 that share the resource that is provided by the shared resource pod 150. In another example, the shared resource pod 150 is disposed on a different node 101 than the node(s) 101 that contain the set of microservice consumer pods 120 that share the resource that is provided by the shared resource pod 150. In another example, a particular set of microservice consumer pods 120 may share multiple resources that are provided by multiple respective shared resource pods 150.

A container, in the context used herein, is a virtual run-time environment for one or multiple software instances and/or software module instances, and this virtual run-time environment is constructed to interface to the operating system 116. A container for a given software instance may, for example, contain the executable code for the software instance and its dependencies, such as system tools, libraries, configuration files, executables and binaries for the software instance. The container contains an operating system kernel mount interface but does not include an operating system kernel. As such, a node 101 may, for example, contain multiple containers, such as the containers of microservice consumer pods 120 and the shared resource pod(s) 150 that share the operating system 116 through respective operating system kernel mount interfaces. Docker containers and rkt containers are examples of containers. The node 101 may contain a container supervisor (not shown), also referred to as a container engine daemon, which performs actions to provide the containers and provide the container pods. In general, the container engine daemon may perform actions to build, run and manage the containers and container pods.

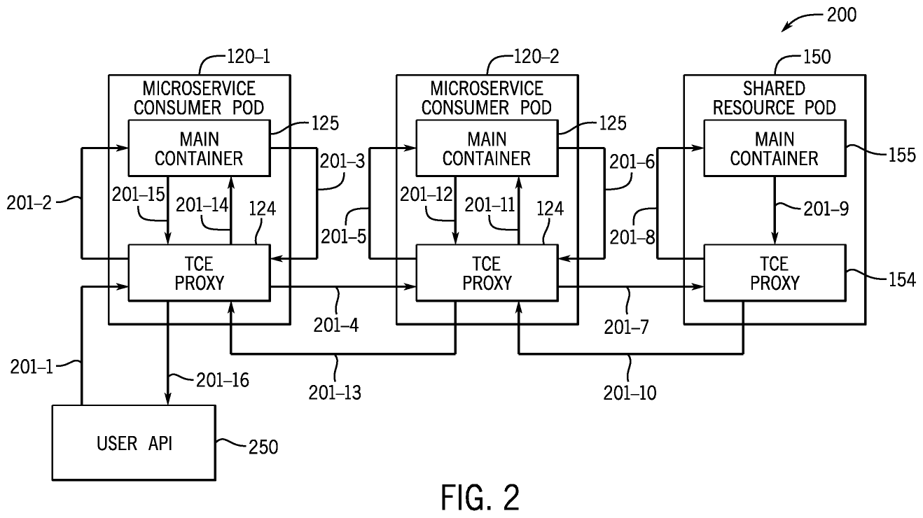

A given microservice consumer pod 120 may be directly or indirectly associated with the consumption of a shared resource that is provided by the shared resource pod 150. For example, FIG. 2 is an illustration of a sequence of communications resulting the consumption of the shared resource and governed by consumer and resource policies in accordance with example implementations.

Referring to FIG. 2, a user API 250 initiates a request 201-1 to the microservice consumer pod 120-1. The request 201-1 is intercepted by the TCE proxy 124 of the microservice consumer pod 120-1. The TCE proxy 124 validates the request 201-1 against an ingress consumer policy of the microservice consumer pod 120-1. As an example, this validation may involve the TCE proxy 124 checking with a network policy enforcer for purposes of determining whether any ingress consumption quotas have been violated. For this example, it is assumed that the validation is successful, and the TCE proxy 124 forwards the request 201-1 by providing another request 201-2 to the main container 125 of the microservice consumer pod 120-1.

The main container 125, in response to the request 201-2 provides an outgoing request 201-3, which is intercepted by the TCE proxy 124 of the microservice consumer pod 120. The TCE proxy 124 validates the request 201-3 against an egress consumer policy of the microservice consumer pod 120-1. As an example, this validation may involve the TCE proxy 124 checking with a network policy enforcer for purposes of determining whether any egress consumption quotas have been violated. For this example, it is assumed that the validation is successful, and the TCE proxy 124 forwards the request 201-3 by providing another request 201-4 to the microservice consumer pod 120-2.

The TCE proxy 124 of the microservice consumer pod 120-2 intercepts the request 201-4 and validates the request 201-4 against an ingress consumer policy of the microservice consumer pod 120-2. For this example, it is assumed that the validation is successful, and the TCE proxy 124 forwards the request 201-4 by providing another request 201-5 to the main container 125 of the microservice consumer pod 120-2.

The main container 125, in response to the request 201-5, sends an outbound request 201-6. The TCE proxy 124 of the microservice consumer pod 120-2 intercepts the request 201-6 and validates the request 201-6 against an egress consumer policy of the microservice consumer pod 120-2. For this example, it is assumed that the validation is successful, and the TCE proxy 124 forwards the request 201-6 by providing another request 201-7 to the shared resource pod 150.

The TCE proxy 124 of the shared resource pod 150 intercepts the request 201-7 and validates the request 201-7 against an ingress resource policy of the shared resource pod 150. For this example, it is assumed that the validation is successful, and the TCE proxy 124 forwards the request 201-7 by providing another request 201-8 to the main container 125 of the shared resource pod 150. The main container 125, in response to the request 201-8, sends an outbound response 201-9.

The TCE proxy 124 of the shared resource pod 150 pod intercepts the outbound response and validates the outbound response 201-9 against an egress resource policy of the shared resource pod 150. For this example, it is assumed that the validation is successful, and the TCE proxy 124 forwards the response 201-9 by providing another response 201-10 to the microservice consumer pod 120-2. The response then propagates back to the API user 250 via responses 201-11, 201-12, 201-13, 201-14, 201-15 and 201-16 that follow the reverse path described above for the responses. In accordance with example implementations, the TCE proxies 124 of the microservice consumer pods 120-1 and 120-2 intercept ingress and egress responses and apply the appropriate consumer policies to successfully validate the responses before allowing the responses to propagate to the next stage of the response path.

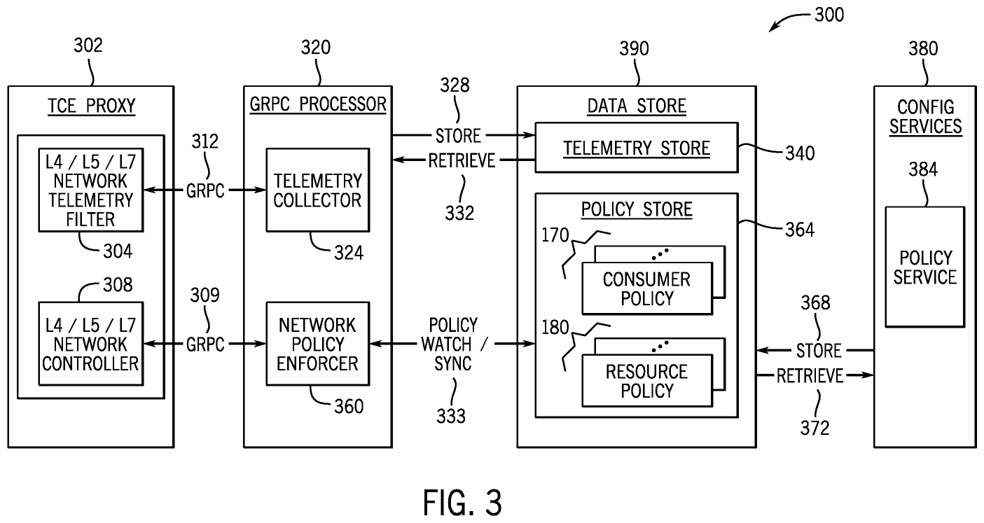

FIG. 3 depicts a microservice architecture 300 used to regulate shared resource usage according to an example implementation. Referring to FIG. 3, the microservice architecture 300 includes a TCE proxy 302, which may be, for example, the TCE proxy 124 or the TCE proxy 154 of FIG. 1. In accordance with example implementations, the TCE proxy 302 includes a network telemetry filter 304 and a network controller 308. In an example, the network telemetry filter 304 and the network controller 308 may be formed by one or multiple hardware processors (e.g., the hardware processors 110 of FIG. 1) executing machine-readable instructions (e.g., instructions stored in the system memory 114 of FIG. 1). In an example, the network telemetry filter 304 and the network controller 308 may be components of a stack-based virtual machine (e.g., a WebAssembly virtual machine).

The network telemetry filter 304 samples, or measures, L4, L5 and/or L7 network telemetry metrics of network traffic that passes through the TCE proxy 302 and to/from the associated main container. The network telemetry filter 304 may communicate with a telemetry collector 324, which aggregates the L4, L5 and/or L7 network telemetry metric measurements to derive ingress cumulative usages and egress cumulative usages. In an example, the telemetry collector 324 may contain various counters to combine measurements of a particular metric for purposes of providing a time rate characterization of the metric (e.g., a time rate of ingress data communicated through the TCE proxy 302 per second or a time rate of egress data communicated through the TCE proxy 302 per hour) and for purposes of deriving total counts corresponding to a particular metric (e.g., a total count of open TCP connections). In accordance with some implementations, the telemetry collector 324 may be part of remote procedure call (RPC) processor 320 (e.g., a GRPC processor) that is external to the TCE proxy 302. Moreover, as depicted in FIG. 3, the RPC processor 320 may include a network policy enforcer 360. The RPC processor 320 may be formed by one or multiple hardware processors (e.g., the hardware processors 110 of FIG. 1) executing machine-readable instructions (e.g., instructions stored in the system memory 114 of FIG. 1). In accordance with example implementations, the network telemetry filter 304 may store recently-acquired measurements in a buffer of the filter 304 and periodically push the contents of the buffer to the telemetry collector 324. In an example, the network telemetry filter 304 may be run in a sandbox environment.

In an example, the telemetry collector 324 may generate both L4 metric-affiliated and L7 metric-affiliated cumulative usages. For example, for L4 metric-affliated cumulative usages, the telemetry collector 324 may include a counter that maintains a count of the total number of open TCP connections for ingress network traffic. In an example, the telemetry collector 324 may include a counter that maintains a count of the total number of open TCP connections for egress network traffic. In another example, the telemetry collector 324 may include a counter that measures an egress network traffic flow volume. For example, the telemetry collector 324 may include a counter that counts the total amount of egress network traffic that passes through the TCE proxy 302 within a trailing time window (e.g., a total amount of egress network traffic in the last minute or a total amount of egress network traffic in the last hour). In other examples, the telemetry collector 324 may include one or multiple counters that measure ingress network traffic flow volumes (e.g., an ingress network traffic flow per minute or an ingress network traffic flow per hour).

As an example of L7-affilated cumulative usages, the telemetry collector 324 may include a counter that counts the number of web page requests associated with ingress network traffic (e.g., the number of web page requests per minute). In another example, the telemetry collector 324 count the number of web page requests associated with egress network traffic.

As depicted in FIG. 3, in accordance with some implementations, the microservice architecture 300 may include a data store 390 that includes a telemetry storage 340. The telemetry collector 324 may, for example, store 328 data representing the observed network metrics in the telemetry storage 340. As depicted at 332, the network policy enforcer 260 may retrieve data representing the observed network metrics. The data store 390 may further include policy storage 364 that stores data represents one or multiple policies, such as consumer policies 170 or resource policies 180. For a TCE proxy 124 for a microservice consumer pod, the policies may include, for example, ingress and egress consumer policies 170. For a TCE proxy 154 for a shared resource pod, the policies may include, for example, ingress and egress capacity policies 180.

In accordance with example implementations, the network policy enforcer 360 performs policy checks for the TCE proxy's network controller 308. In this manner, accordance with example implementations, the network controller 308 intercepts ingress and egress network requests, and for each intercepted network request, the network controller 308 sends a policy check request to the network policy enforcer 360. The network policy enforcer 360, in response to the policy check request, determines whether the applicable cumulative usage(s) comply with the corresponding quotas, and the network policy enforcer 360, based on this determination, sends a response back to the network controller 308 either permitting or denying the network traffic request.

For example, the network controller 308 of a TCE proxy 124 of a microservice consumer pod may intercept an ingress network traffic flow request and send a policy check request to the network policy enforcer 360. The network policy enforcer 360, in response to the policy check request, may determine whether ingress cumulative usages comply with the applicable consumer policy quotas. In an example, ingress consumption quotas may be 2 Mb/h and 200 Kb/s. For this example, the ingress cumulative usages may be 1 Mb/h and 300 Kb/s. If the 200 Kb/s consumption quota is a hard limit, the network policy enforcer 360 strictly enforces the 200 Kb/s consumption quota and correspondingly sends a deny response to the network controller 308. If the 200 Kb/s consumption quota is a soft limit, the network policy enforcer 360 may send an allow response to the network controller 308, depending on how the network policy enforcer 360 handles the soft limit. In an example, the ingress consumer policy may identify the 200 Kb/s consumption quota as being a soft limit, and moreover, in accordance with some implementations, the ingress consumer policy may specify how to handle the soft limit (e.g., specify a time tolerance, a magnitude variation of other soft limit handling policy).

The network policy enforcer 360 may regularly check (e.g., periodically poll or receive a notification) the policy storage 364 for purposes of detecting when a policy is updated, added or deleted. When the network policy enforcer 360 detects such a policy change, the network policy enforcer 360 updates its corresponding rules and quotas. In an example, the updating of the network policy enforcer 360 due to a policy addition, modification or deletion may involve changing program code of the network policy enforcer 360. In another example, updating of the network policy enforcer 360 due to a policy addition, modification or deletion may involve changing a configuration of the network policy enforcer 360. As another example, updating of the network policy enforcer 306 due to a policy addition, modification or deletion may involve restarting the network policy enforcer 360. Because the network policy enforcer 360 is not part of the TCE proxy 124, 154, however, any of these events does not cause the network controller 308 or any other component of the TCE proxy 124, 154 or associated pod to experience down time. Accordingly, a policy may be updated, deleted or added while operation of the associated microservice or resource remains continuous and uninterrupted.

In addition to specifying one or multiple consumption quotas (for a consumer policy) or one or multiple capacity quotas (for a resource policy), in accordance with some implementations, a particular policy may specify one or multiple other criteria, which may control whether or not a network request is allowed or denied. In an example, a policy may specify one or multiple L7-related, criteria that, if met, result in a network request being rejected, irrespective of whether the quotas of the policy have been met or exceeded. For example, the nodes of the computer system may be IoT devices, and some IoT devices may be considered to not meet certain security standards. A particular consumer or resource policy may, for example, specify that network requests that are associated with certain device types (e.g., a particular IoT device type, as indicated by an L7 device type) are to be rejected. In another example, a particular consumer or resource policy may specify that network requests associated with certain client IDs (e.g., an L7-derived client ID) are to be rejected. In another example, a particular consumer or resource policy may specify that network requests corresponding to certain UDP messages (e.g., duplicate messages, broadcast messages, unicast messages, or messages from certain message sources) are to be rejected. In other examples, a policy may specify one set of quotas for certain non-quota-affiliated criteria (e.g., the policy may specify a first set of quotas for messages associated with a first class of devices) and further specify another set of quotas for other non-quota-affiliated criteria (e.g., the policy may specify a second set of quotas for messages associated with a second class of devices).

In another example, a policy may specify one or multiple transport layer, or L5-related, criteria that, if met, result in a network request being rejected, irrespective of whether the consumption quotas are met. In an example, a consumer or resource policy may specify a minimum version of a security protocol, such that messages that correspond to less secure versions of the security protocol are rejected. For example, a consumer or resource policy may specify that a message that is not associated with version 1.3 of the Transport Layer Security (TLS) protocol or higher is rejected.

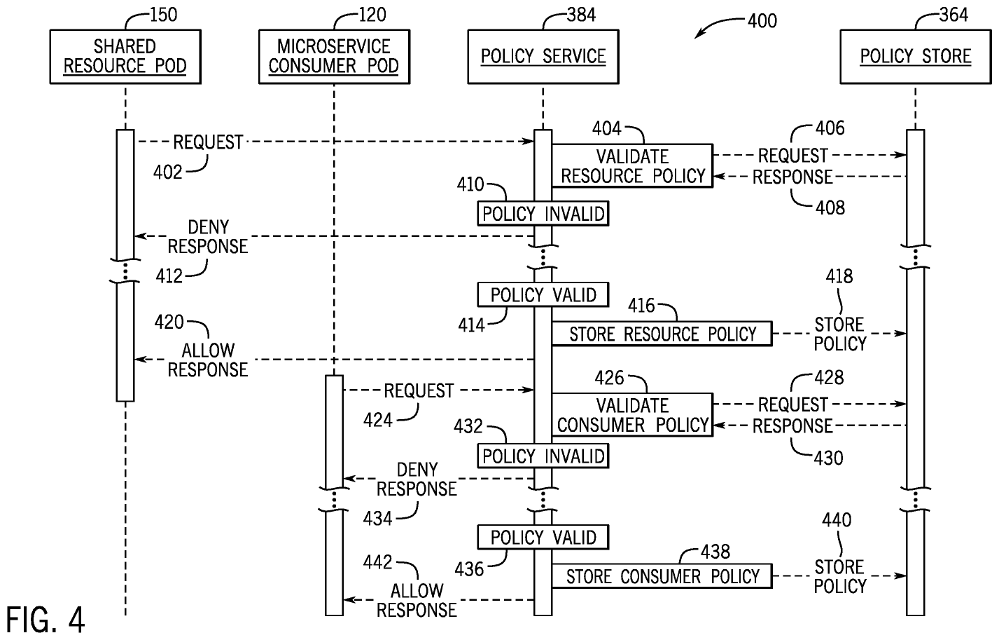

In accordance with example implementations, a policy may be added, deleted or modified by a policy service 384, which may be part of a set of configuration services 380. In an example, a user or administrator may use the policy service 384 to add, delete or modify a policy 365. FIG. 4 depicts a sequence 400 illustrating the creation of consumer and capacity policies according to an example implementation.

Referring to FIG. 4, the sequence 400 first depicts a failed attempt to create a resource policy for a shared resource pod 150. A request 402 on behalf of the shared resource pod 150 (e.g., a request submitted by a user or administrator) is submitted to the policy service 384. In an example, the request 402 may identify a proposed ingress resource policy or a proposed egress resource policy that has been stored in the policy store 364. In another example, the request 402 may reference changes to an existing resource policy that is stored in the policy store 364 for purposes of modifying the existing resource policy to form the proposed resource policy. The proposed resource policy may, for example, specify one or multiple policy criteria, such as one or multiple capacity quotas. The policy service 384 may first validate the proposed policy, as depicted at 404. In an example, for purposes of validating the proposed policy, the policy service 384 may access (as depicted at 406 and 408) the policy store 364 for such purposes as retrieving a proposed resource policy identified by the request 402 from the policy store 64 and retrieving a reference resource policy template.

In an example, the validation 404 of proposed resource policy may involve determining whether the proposed resource policy conforms to a reference resource policy template. In an example, validating a proposed resource policy may involve determining whether the proposed resource policy complies with a set of resource policy syntax and semantics. In an example, validating a proposed resource policy may involve determining whether the proposed resource policy contains at least one capacity quota. In an example, validating a proposed resource policy may involve determining whether there are inconsistencies among capacity quotas of the proposed resource policy. In another example, validating a proposed resource policy may include determining whether a capacity quota is specified, which does not correspond to an approved list of capacity quota categories. In another example, validating a proposed resource policy may include validating a digital signature of the proposed policy. The policy service 384 may use additional and/or different criteria than the foregoing examples for purposes of validating a proposed resource policy.

In accordance with some implementations, the policy service 384 may regularly perform resource policy recordkeeping operations, such as scanning the policy store 364 to identify any resource policies that are not being used or are being underutilized (e.g., less than a predetermined number of shared resources are using the policy, or other criteria). In accordance with some implementations, the resource policy recordkeeping operations may include the policy service 384 deleting resource policies that are not being used. Moreover, in accordance with some implementations, the resource policy recordkeeping operations may include the policy service 384 sending out a notification for an unused or underutilized resource policy, informing that the resource policy will be deleted by a certain time and date.

For the example sequence 400, the policy service 384 determines that the proposed resource policy that corresponds to the request 402 is invalid, as depicted at 410. Consequentially, the policy service 384 sends out a response 412 denying the proposed resource policy.

Other proposed resource policies may pass policy validation. FIG. 4 depicts the policy service 384 validating a proposed resource policy at 414. In response to determining that the proposed resource policy is valid, the policy service 384 stores the policy in the policy store 364, as depicted at 416 and 418, and the policy service 384 sends an allow response 420 indicates that the resource policy was added to the policy store 364.

The sequence 400 also depicts a failed attempt to create a consumer policy for a microservice consumer pod 120. A request 424 on behalf of a microservice consumer pod 120 (e.g., a request submitted by a user or administrator) is submitted to the policy service 384 for purposes of identify a proposed ingress consumer policy or an egress consumer policy that has been stored in the policy store 364. In another example, the request 424 may reference changes to an existing consumer policy that is stored in the policy store 364 for purposes of modifying the existing consumer policy to form the proposed consumer policy. The proposed consumer policy may, for example, specify one or multiple policy criteria, such as one or multiple consumption quotas. The policy service 384 may then validate the proposed consumer policy, as depicted at 426. In an example, for purposes of validating the proposed consumer policy, the policy service 384 may access (as depicted at 428 and 430) the policy store 364 for such purposes as retrieving a policy identified by the request 424 and retrieving a consumer policy template.

In an example, the validation 426 of proposed consumer policy may involve determining whether the proposed consumer policy conforms to a reference consumer policy template. In an example, validating a proposed consumer policy may involve determining whether the proposed consumer policy complies with a set of consumer policy syntax and semantics. In an example, validating a proposed consumer policy may involve determining whether the proposed resource policy contains at least one consumption quota. In an example, validating a proposed consumer policy may involve determining whether there are inconsistencies among consumption quotas of the proposed consumer policy. In another example, validating a proposed consumer policy may include determining whether a consumption quota is specified, which does not correspond to an approved list of consumption quota categories. In another example, validating a proposed consumer policy may include determining whether a consumption quota is outside of a permitted range of quota values for the consumption quota category. In another example, validating a proposed consumer policy may include determining whether a consumption quota is inconsistent with a corresponding capacity quota of the resource policy. For example, a proposed consumer policy may specify a consumption quota of 2 Gb/s for egress data, and the resource policy may specify a capacity quota of 2 Gb/s or less. In another example, validating a proposed consumer policy may include validating a digital signature of the proposed consumer policy. The policy service 384 may use additional and/or different criteria than the foregoing examples for purposes of validating a proposed consumer policy.

For the example depicted in FIG. 4, the policy service 384 determines that the proposed consumer policy of the request 424 is invalid, as depicted at 432. Accordingly, the policy service 384 sends a deny response, as depicted at 434.

Other proposed resource policies may pass policy validation. FIG. 4 depicts the policy service 384 validating a proposed consumer policy at 436. In response to determining that the proposed consumer policy is valid, the policy service 384 stores the resource policy in policy store 364, as depicted at 438 and 440, and the policy service 384 sends an allow response 442 that indicates that the resource policy was added to the policy store 364.

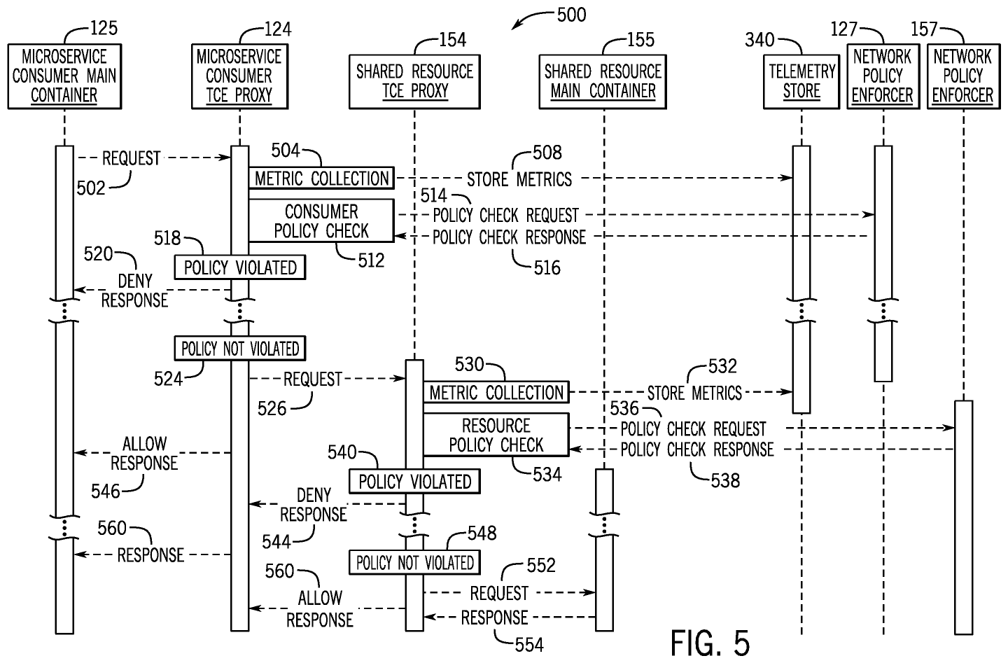

FIG. 5 depicts a sequence diagram 500 illustrating the enforcement of shared resource usage using resource and consumer polices according to an example implementation. Referring to FIG. 5, a main container 125 of a shared microservice consumer pod provides a network request 502 to communicate network traffic with a shared resource pod. A TCE proxy 124 of the microservice consumer pod intercepts the request 502. The TCE proxy 124 performs ongoing measurement of network flow metrics, as depicted at 504, and these metrics may be stored in a telemetry store 340, as depicted at 508.

The TCE proxy 124, in response to the request 502, performs a consumer policy check 512. Performing the consumer policy check includes the TCE proxy 124 providing a policy check request to a network policy enforcer 127, as depicted at 514, and performing the policy check request further includes the TCE proxy 124 receiving a policy check response from the network policy enforcer 127, as depicted at 516. For this particular example, the network policy enforcer 127 determines that the request 502 does not comply with a consumer policy and, the policy check response 516 denies the request 502. Accordingly, the TCE proxy 124 determines that the policy is violated, as depicted at 518, the TCE proxy 124 does not allow the request to proceed to the main container 125, and the TCE proxy 124 sends a deny response 520 to the main container 125.

Other network requests associated with the microservice consumer pod may comply with the consumer policies. The sequence diagram 500 further depicts a determination 524 by the TCE proxy 124 that a network request complies with the consumer policies. This determination may be made by the TCE proxy 124 using the network policy enforcer 127. In response to the determination 524 that none of the consumer policies have been violated, the TCE proxy 124 allows the request to proceed to the main container 125, and the TCE proxy 124 sends an allow response 546 to the main container 125.

The sequence diagram 500 further depicts a request 526 being sent to the shared resource and being intercepted by a TCE proxy 154 of the shared resource pod. As also depicted in FIG. 5, the TCE proxy 154 observes network flow metrics associated with the shared resource pod, as depicted at 530, and these metrics may be stored in the data store 390. The TCE proxy 154, in response to intercepting the request 526, performs a resource policy check 534. Performing the resource policy check includes the TCE proxy 154 providing a policy check request to a network policy enforcer 157, as depicted at 536, and further includes receiving a policy check response from the network policy enforcer 157, as depicted at 538. For this particular example, the network policy enforcer 360 determines that the request 526 does not comply with a resource policy and, the policy check response 538 denies the request 526. Accordingly, the TCE proxy 154 determines that the policy is violated, as depicted at 540, the TCE proxy 154 does not allow the request to proceed to the main container 155 of the shared resource pod, and the TCE proxy 1544 sends a deny response 544 to the main container 155.

Other network requests associated with the shared resource pod may comply with the resource policies. The sequence diagram 500 further depicts a determination 548 by the TCE proxy 124 that a network request complies with the resource policies. This determination may be made by the TCE proxy 124 using the network policy enforcer 157. In response to the determination 548 that none of the resource policies have been violated, the TCE proxy 124 allows the request to proceed to the main container 155, and the TCE proxy 124 sends an allow response 560 to the main container 155.

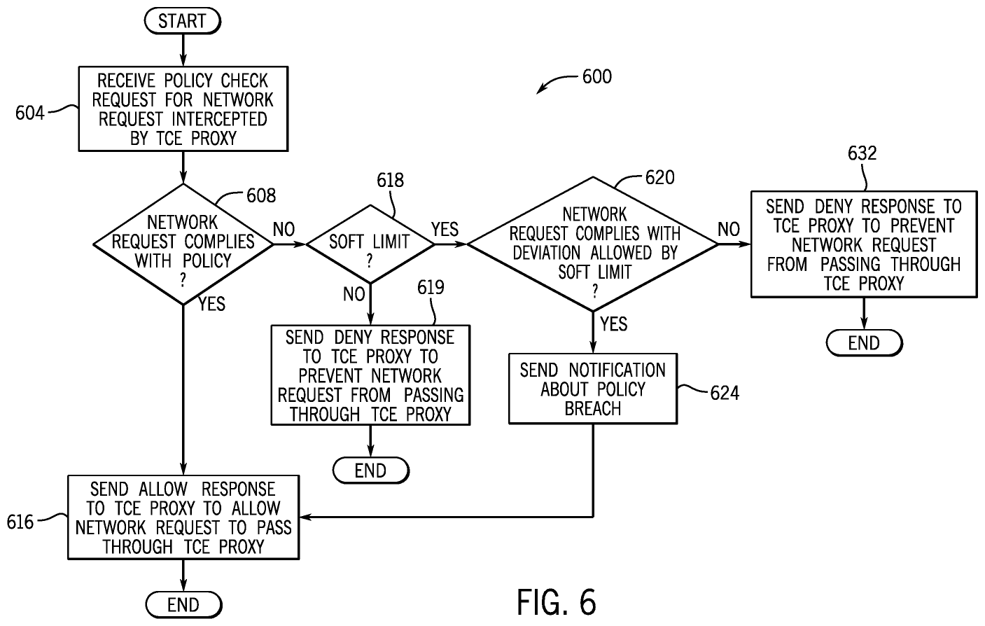

FIG. 6 is a flow diagram depicting a process 600 to soft handle a policy quota violation in accordance with example implementations. Stated differently, the quota may be a soft limit. As an example, the process 600 may be performed by a network policy enforcer, in accordance with some implementations.

Referring to FIG. 6, the process 600 includes pursuant to block 604, receiving (block 604) a policy check request for a network request that is intercepted by a TCE proxy. If, according to decision block 608, the request complies with the applicable policy, then the process 600 includes sending an allow response to the TCE proxy to allow the network request to pass through the TCE proxy, pursuant to 616.

As depicted in FIG. 6, if, according to decision block 608, the network request does not comply with the policy, then an evaluation is made regarding whether the violated quota was a soft limit or a hard limit, pursuant to decision block 620. In an example, this decision may involve determining whether the policy defines the violated quota as being a soft limit or a hard limit. If the violated quota is a hard limit, then, pursuant to block 619, the process 600 includes sending a deny response to the TCE proxy to prevent the network request from passing through the TCE proxy.

If, according to decision block 618, the violated quota is a soft limit, then, in accordance with example implementations, a determination is made, pursuant to decision block 620, whether the network request complies with a deviation that is allowed by the soft limit. In an example, the deviation may be specified by the policy. In an example, the deviation may be time-based and allow a network request to proceed if the quota violation occurs within a predefined time period (e.g., time period commensurate with one or multiple predefined bus cycles). In an example, an initial violation may trigger the beginning of the predefined time period so that all network requests that are received within the predefined time period are allowed to pass. In another example, the deviation may be magnitude, or value-based, such that a certain deviation from the quota is allowed (e.g., a ten percent variation). A soft limit may be handled in other ways, in accordance with further variations.

As depicted in FIG. 6, in accordance with example implementations, if, pursuant to decision block 620, a determination is made that the network request complies with the deviation allowed by the soft limit, then, pursuant to block 624, a notification about the policy breach is sent out (e.g., sent as a message to an administrator and/or logged as an event), and pursuant to block 616, an allow response is sent to the TCE proxy to allow the network request to pass through the TCE proxy. If, however, pursuant to decision block 620, a determination is made that the network request does not comply with the deviation allowed by the soft limit, then, pursuant to block 632, a deny response is sent to the TCE proxy to prevent the network request from pass through the TCE proxy.

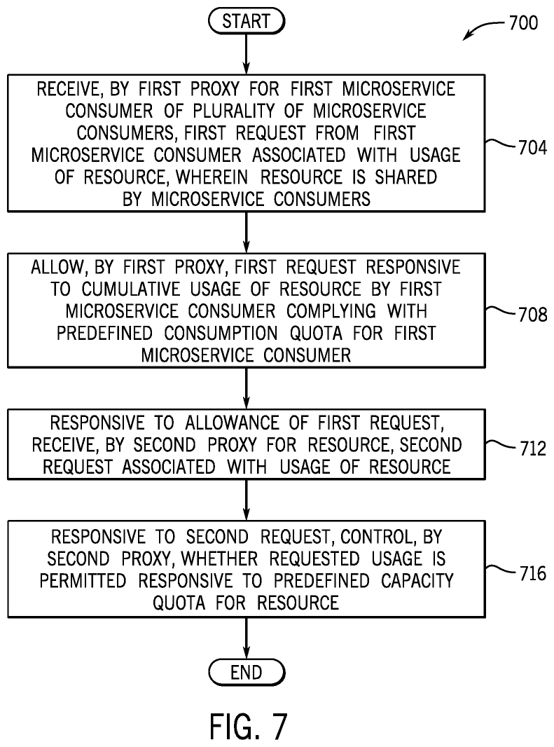

Referring to FIG. 7, in accordance with example implementations, a process 700 includes receiving (block 704), by a first proxy for a microservice consumer of a plurality of microservice consumers, a first request from the microservice consumer, for a usage of a resource. The resource is shared by the microservice consumers. In an example, the resource may be shared by multiple microservice consumers that are associated with the same application. In an example, each microservice consumer of the multiple microservice consumers may be associated with a consumer service pod of containers. In an example, the microservice consumer requested the usage of the shared resource may correspond to a pod of containers, which includes a main container and a sidecar pattern container. In an example, the sidecar pattern container may be a microservice consumer traffic control edge (TCE) proxy, which regulates, or controls network traffic that is communicated with the main container. In an example, the microservice consumer TCE proxy may regulate ingress traffic to the main container and egress traffic from the main container based on a microservice consumer policy.

In an example, the microservice consumer TCE proxy may communicate with a traffic enforcer, which is external to the pod, for purposes of checking whether network traffic into and/or out of the main container is permitted per a consumer policy The traffic enforcer may determine, for a given check, whether the request is permitted based on a quota that is established by the resource consumer policy and a monitored traffic history associated with the main container. In an example, the monitored traffic history may include level four (L4) and/or (L7) network metrics.

The process 700 includes allowing (block 708), by the first proxy, the first request responsive to a cumulative usage of the resource by the first microservice consumer complying with a predefined consumption quota for the first microservice consumer. In examples, the consumption quota may be an ingress traffic flow quota or an egress traffic flow quota. In an example, the consumption quota may be an amount of traffic flow over a predefined time period. In an example, the consumption quota may be a number of open connections by the microservice consumer over a predefined time period.

Determining whether the requested usage complies with the consumption quota may include evaluating a consumer policy that contains the consumption quota and other consumption quotas for the first microservice consumer. In an example, the consumption quota may be a hard limit, and determining whether the requested usage complies with the consumption quota may be strictly enforced, such that a requested usage that exceeds the quota is denied. In another example, the consumption quota may be a soft limit, and determining whether the requested usage complies with the quota includes allowing non-compliance with the consumption quota based on a variance, or a deviation, from the consumption quota. In an example, the deviation may be time-based such that the requested usage complies with the consumption quota if the requested usage exceeds the consumption quota within a specified time frame. In another example, the deviation may be magnitude-based, or value-based, such that the requested usage complies with the consumption quota if the requested usage exceeds a predetermined variance above the consumption quota.

The process 700 includes responsive to allowance of the first request, receiving (block 712), by a second proxy for the resource, a second request associated with the usage of the resource. In an example, the first proxy may provide the second request. In another example, a proxy associated with another microservice consumer may provide the second request responsive to the first request. The process 700 includes, responsive to the second request, controlling (block 716), by the second proxy, whether the requested usage is permitted responsive to a predefined capacity quota for the shared resource.

Controlling whether the requested usage is permitted may include evaluating capacity quotas that are specified by a resource policy for the resource. In an example, the resource policy may specify one or multiple capacity quotas that correspond to actual maximum capacities of the resource. In another example, the resource policy may specify one or multiple capacity quotas that are less than corresponding actual maximum capacities of the resource. In an example, a capacity quota may be specified in terms of a network traffic metric, such as a layer four (L4) metric or a layer 7 (L7) metric. In an example, a capacity quota may define a time rate of network data communicated into or out of the resource, a number of open network connections (e.g., transport control protocol (TCP) connections) for the resource, or a time rate of concurrent network connections. In an example, a capacity quota may be the maximum total amount of egress data that is allowed to be handled by the resource in a predefined time period. In another example, a capacity quota may be the maximum amount of ingress data that is allowed to be handled by the in a predefined time period. In another example, a capacity quota may be the maximum number of web page requests that is allowed to be handled by the shared resource in a predefined amount of time.

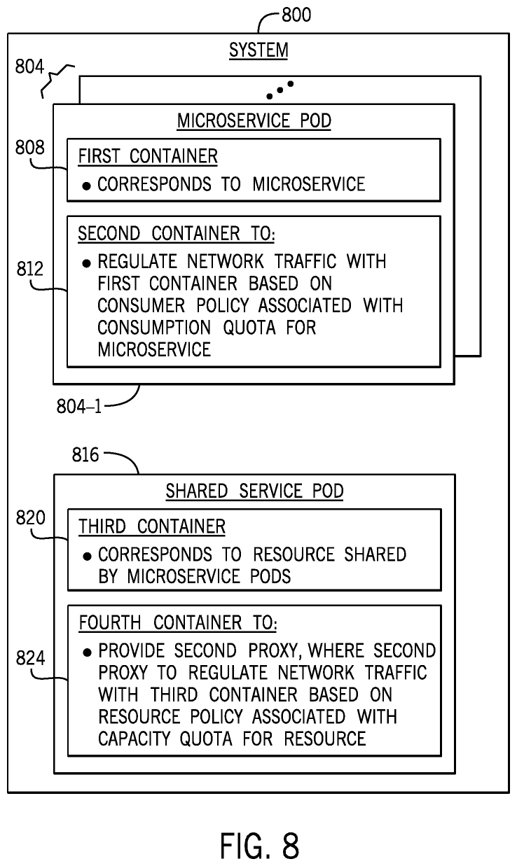

Referring to FIG. 8, in accordance with example implementations, a system 800 includes a plurality of microservice pods 804 that share a resource. In an example, the microservice pods may be respective groups of containers. The resource may be a unit of storage or processing. In an example, the resource may be a message broker. In another example, the resource may be a database. In another example, the resource may be an application programming interface (API).

In an example, the microservice pods 804 may be associated with different microservices, and the microservices may correspond to respective parts of an application. In another example, the microservices may correspond to multiple applications. In an example, the microservice pods 804 may be located on one or multiple computer nodes. In an example, the computer nodes may be actual physical computer platforms. In another example, the computer nodes may be respective abstractions of computer hardware and software.

The microservice pods 804 include a microservice pod 804-1, which includes a first container 808 that corresponds to a microservice and a second container 812. In an example, the first container 808 may be a main container of the pod 804-1. In an example, the second container 812 may be a sidecar pattern container. In an example, the side pattern container may have access to a set of resources (e.g., storage and network resources) that are shared by the sidecar pattern container with the first container 808. In an example, the second container 812 may be a proxy that controls network traffic into and out of the first container 808.

The second container 812 regulates network traffic with the first container 808 based on a consumer policy that is associated with a consumption quota for the microservice. In an example, a consumption quota may be an L4-related consumption limit that is placed on a microservice consumer, such as a limit on an ingress data rate, a limit on an egress data rate or a limit on a rate of concurrent TCP connections. In another example, a consumption quota may be associated with an L7-related consumption limit that is placed on a microservice consumer, such as a limit on the time of web page requests or HTTP requests by the microservice consumer. A given consumer policy may, in general, have zero, one or multiple L4-related consumption limits and zero, one or multiple L7-related consumption limits.

The system 800 includes a shared service pod 816 that includes a third container 820 that corresponds to the resource. In an example, the third container 820 may be a main container of the shared service pod 816, which is associated with provided the resource. The shared service pod includes a fourth container 824 that provides a second proxy. The second proxy regulates network traffic with the third container based on a resource policy, which is associated with capacity quotas for the resource. In an example, the second proxy may be a sidecar pattern container. In an example, the sidecar pattern container may share resources (e.g., storage and network resources) with the third container 820.

In an example, the second proxy may communicate with a traffic policy enforcer, which is external to the shared service pod 816, for purposes of checking whether network traffic into and/or out of the third container 820 main container is permitted per the resource policy The traffic enforcer may determine, for a given check, whether the request is permitted based on a capacity quota of the resource policy and a monitored, or observed, network usage with the third container 820. In an example, the observed network traffic, as well as capacity quotas of the resource policy may correspond to level four (L4) and/or (L7) network metrics. In an example, the traffic policy enforcer may monitor a policy repository for purposes of detecting whether the resource policy has been modified. In an example, the traffic policy enforcer may restart in response to the traffic policy enforcer detecting a modified resource policy for purposes of updating rules applied by the traffic policy according to the resource policy. In an example, the second proxy does not restart due to the resource policy being modified.

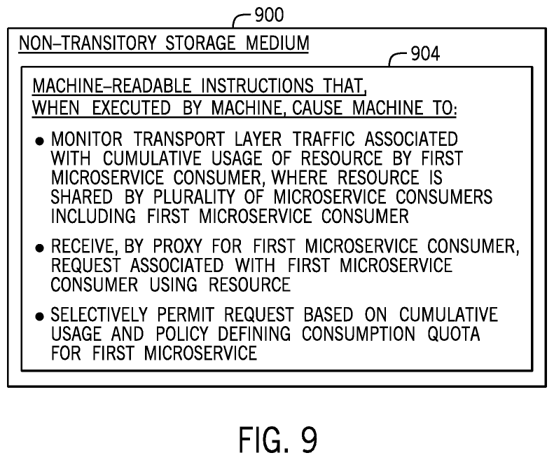

Referring to FIG. 9, in accordance with example implementations, a non-transitory storage medium 900 stores machine-readable instructions 904. The instructions 904, when executed by a machine, cause the machine to monitor transport layer traffic associated with a cumulative usage of a resource by a first microservice consumer. The resource is shared by a plurality of microservice consumers including the first microservice consumer. In examples, the microservice consumers may be associated with one application or multiple applications. The resource may be a unit of storage or processing. In an example, the resource may be a message broker. In another example, the resource may be a database. In another example, the resource may be an application programming interface (API). In an example, monitoring the transport layer traffic may include monitoring an amount of ingress data per unit time period (e.g., monitoring Mb/s) received by the first microservice consumer and/or monitoring an amount of egress data per unit of time transmitted by the first microservice consumer. In an example, monitoring the transport layer traffic may include monitoring a number of open connections (e.g., TCP connections) per unit time used by the first microservice consumer.

The instructions 904, when executed by the machine, further cause the machine to receive, by a proxy for the first microservice consumer, a request that is associated with the first microservice consumer using the resource. In an example, the proxy may be a sidecar pattern container. In an example, the sidecar pattern container may be part of a pod of containers that includes a main container that corresponds to the first microservice consumer. In an example, the sidecar pattern container may share resources (e.g., storage and network resources) with the main container. In an example, the request may result in data being transferred to the resource. In another example, the request may result in data being transferred from the resource.

The instructions 904, when executed by the machine, further cause the machine to selectively permit the request based on the cumulative usage and a policy defining a consumption quota for the first microservice consumer. In an example, the policy may specify multiple consumption quotas for the first microservice consumer. In examples, a consumption quota may be a limit on ingress data received by the first microservice consumer, a limit on egress data provided by the first microservice consumer or a time rate of open TCP connections associated with the first microservice consumer.

Selectively permitting the request may include the proxy communicating with a traffic policy enforcer. In an example, the traffic policy enforcer may be external to a pod that contains the proxy. In an example, the traffic policy enforcer may perform a check of the policy based on observed transport layer traffic with the first microservice consumer to determine whether the request would violate a consumption quota of the policy. In example, the traffic policy enforcer may poll a policy repository for purposes of detecting whether the policy has been modified. In an example, the traffic policy enforcer may restart in response to the traffic enforcer detecting a modified resource policy for purposes of updating rules applied by the traffic policy according to the resource policy. In an example, the proxy does not restart in response to the resource policy being modified. In an example, checking whether the quota is violated may include enforcing a hard limit on the quota. In another example, checking whether the quota is violated may include enforcing a soft limit on the quota.

In accordance with example implementations, the cumulative usage includes a time rate of data communicated by the first microservice consumer. The predefined consumption quota includes a limit on the time rate of data. Allowing the first request includes approving the first request based on a comparison of the time rate of data to the limit. Particular advantages include regulating usage of a shared resource by microservice consumers without modifying microservice code and without incurring microservice downtime to implement resource policy changes or microservice consumer policy changes.

In accordance with example implementations, allowing the first request includes determining that the predefined consumption quota corresponds to a hard limit. Approving the first request further includes, responsive to determining that the predefined consumption quota corresponds to the hard limit, determining whether the cumulative usage exceeds the predefined consumption quota. Allowing the first request further includes approving the first request responsive to determining that the cumulative usage does not exceed the predefined consumption quota. Particular advantages include regulating usage of a shared resource by microservice consumers without modifying microservice code and without incurring microservice downtime to implement resource policy changes or microservice consumer policy changes.

In accordance with example implementations, allowing the first request includes determining that the predefined consumption quota corresponds to a soft limit; and responsive to determining that the predefined consumption quota corresponds to the soft limit, approving the first request based on the cumulative usage and a variance that is applied to the predefined consumption quota. Particular advantages include regulating usage of a shared resource by microservice consumers without modifying microservice code and without incurring microservice downtime to implement resource policy changes or microservice consumer policy changes.

In accordance with example implementations, the variance includes a time-based deviation that allows noncompliance with the consumption quota for a predefined time period. Particular advantages include regulating usage of a shared resource by microservice consumers without modifying microservice code and without incurring microservice downtime to implement resource policy changes or microservice consumer policy changes.

In accordance with example implementations, the variance includes a value-based deviation to the consumption quota. Particular advantages include regulating usage of a shared resource by microservice consumers without modifying microservice code and without incurring microservice downtime to implement resource policy changes or microservice consumer policy changes.

In accordance with example implementations, the predefined consumption is a limit that corresponds to a network telemetry metric that is associated with a network transport layer or a network application layer. Particular advantages include regulating usage of a shared resource by microservice consumers without modifying microservice code and without incurring microservice downtime to implement resource policy changes or microservice consumer policy changes.

In accordance with example implementations, the predefined consumption quota is specified by a consumer policy that is associated with the first microservice consumer. The consumer policy further specifies at least one of a condition that is associated with a network session layer or a condition that is associated with a network transport layer. Allowing the first request includes approving the first request based on the first request being associated with at least one characteristic that satisfies the condition(s) associated with the network session layer or the condition(s) associated with the network transport layer. Particular advantages include regulating usage of a shared resource by microservice consumers without modifying microservice code and without incurring microservice downtime to implement resource policy changes or microservice consumer policy changes.

In accordance with example implementations, the predefined consumption quota is specified by a consumer policy that is associated with the first microservice consumer. The microservice consumer is associated with a pod of containers. The pod of containers includes a main container to provide a microservice and a sidecar pattern container corresponding to the first proxy. Allowing the first request includes the sidecar pattern container communicating with a network policy enforcer external to the pod to cause the network policy enforcer to check a consumer policy and determine, based on the check, that the cumulative usage complies with the predefined consumption quota. Particular advantages include regulating usage of a shared resource by microservice consumers without modifying microservice code and without incurring microservice downtime to implement resource policy changes or microservice consumer policy changes.

In accordance with example implementations, the consumer policy may be changed. The network policy enforcer detects the changing of the consumer policy. The network policy enforcer is updated responsive to the detection without changing any configuration of the pod that is associated with the first microservice consumer. The network policy enforcer is updated responsive to the detection without changing any program code that is associated with the pod that is associated with the first microservice consumer. The network policy enforcer is updated responsive to the detection without introducing a down time for the pod that is associated with the first microservice consumer. Particular advantages include regulating usage of a shared resource by microservice consumers without modifying microservice code and without incurring microservice downtime to implement resource policy changes or microservice consumer policy changes.

In accordance with example implementations, the predefined capacity quota is specified by a resource policy that is associated with the resource. The resource is associated with a pod of containers. The pod of containers includes a main container to provide the resource and a sidecar pattern container corresponding to the second proxy. Controlling whether the requested usage of the shared resource is permitted includes communicating with a network policy enforcer external to the pod to cause the network policy enforcer to check the resource policy and determine, based on the check, that a cumulative usage of the shared resource complies with the predefined capacity quota. Particular advantages include regulating usage of a shared resource by microservice consumers without modifying microservice code and without incurring microservice downtime to implement resource policy changes or microservice consumer policy changes.

In accordance with example implementations, the network enforcer determines, based on the resource policy, whether a hard limit or a soft limit applies to the capacity. The second request is approved based on the determination of whether of not the hard limit or the soft limit applies to the capacity quota and a cumulative usage of the resource. Particular advantages include regulating usage of a shared resource by microservice consumers without modifying microservice code and without incurring microservice downtime to implement resource policy changes or microservice consumer policy changes.

In accordance with example implementations, the resource policy changes. The network policy enforcer detects the changing of the resource policy. The network policy enforcer is updated responsive to the detection without changing any configuration of the pod that is associated with the resource. The network policy enforcer is updated responsive to the detection without changing any program code that is associated with the pod that is associated with the resource. The network policy enforcer is updated responsive to the detection without introducing a down time for the pod that is associated with the resource. Particular advantages include regulating usage of a shared resource by microservice consumers without modifying microservice code and without incurring microservice downtime to implement resource policy changes or microservice consumer policy changes.

While the present disclosure has been described with respect to a limited number of implementations, those skilled in the art, having the benefit of this disclosure, will appreciate numerous modifications and variations therefrom. It is intended that the appended claims cover all such modifications and variations.

1. A method comprising:
receiving, by a first proxy for a first microservice consumer of a plurality of microservice consumers, a first request from the first microservice consumer associated with a usage of a resource, wherein the resource is shared by the plurality of microservice consumers;
allowing, by the first proxy, the first request responsive to a cumulative usage of the resource by the first microservice consumer complying with a predefined consumption quota for the first microservice consumer;
responsive to allowance of the first request, receiving, by a second proxy for the resource, a second request associated with the usage of the resource; and
responsive to the second request, controlling, by the second proxy, whether the second request is permitted responsive to a predefined capacity quota for the resource.

2. The method of claim 1, wherein:
the cumulative usage comprises a time rate of data communicated by the first microservice consumer;
the predefined consumption quota comprises a limit on the time rate of data; and
allowing the first request comprises approving the first request based on a comparison of the time rate of data to the limit.

3. The method of claim 1, wherein allowing the first request comprises:
determining that the predefined consumption quota corresponds to a hard limit;
responsive to determining that the predefined consumption quota corresponds to the hard limit, determining whether the cumulative usage exceeds the predefined consumption quota; and
approving the first request responsive to determining that the cumulative usage does not exceed the predefined consumption quota.

4. The method of claim 1, wherein approving the first request comprises:
determining that the predefined consumption quota corresponds to a soft limit; and
responsive to determining that the predefined consumption quota corresponds to the soft limit, approving the first request based on the cumulative usage and a variance applied to the predefined consumption quota.

5. The method of claim 4, wherein the variance comprises a time-based deviation that allows noncompliance with the predefined consumption quota for a predetermined time period.

6. The method of claim 4, wherein the variance comprises a comprises a value-based deviation that adjusts the predefined consumption quota.

7. The method of claim 1, wherein the predefined consumption quota comprises a limit corresponding to a network telemetry metric associated with a network transport layer or a network application layer.

8. The method of claim 1, wherein:
the predefined consumption quota is specified by a consumer policy associated with the first microservice consumer;
the consumer policy further specifies at least one of a condition associated with a network session layer or a condition associated with a network transport layer; and
allowing the first request comprises approving the first request based on the first request being associated with at least one characteristic that satisfies the at least one of the condition associated with a network session layer or the condition associated with a network transport layer.

9. The method of claim 1, wherein:
the predefined consumption quota is specified by a consumer policy associated with the first microservice consumer;
the microservice consumer is associated with a pod of containers;
the pod of containers comprises a main container to provide a microservice and a sidecar pattern container corresponding to the first proxy; and
allowing the first request comprises the sidecar pattern container communicating with a network enforcer external to the pod to cause the network enforcer to check the consumer policy and determine, based on the check, that the cumulative usage complies with the predefined consumption quota.

10. The method of claim 9, further comprising:
changing the consumer policy;
detecting, by the network policy enforcer, the changing of the consumer policy;
updating the network policy enforcer responsive to the detection without changing any configuration of the pod;
updating the network policy enforcer responsive to the detection without changing any program code associated with the pod; and
updating the network policy enforcer responsive to the detection without introducing a down time for the pod.

11. The method of claim 1, wherein:
the predefined capacity quota is specified by a resource policy associated with the resource;
the resource is associated with a pod of containers;
the pod of containers comprises a main container to provide the resource and a sidecar pattern container corresponding to the second proxy; and
controlling whether the requested usage is permitted comprises communicating with a network policy enforcer external to the pod to cause the network policy enforcer to check the resource policy and determine, based on the check, that a cumulative usage of the shared resource complies with the predefined capacity quota.

12. The method of claim 11, further comprising:
determining, by the network policy enforcer, whether a hard limit or a soft limit applies to the predefined capacity quota; and
approving the second request based on the determination of whether the hard limit or the soft limit applies to the capacity quota and a cumulative usage of the resource.

13. The method of claim 11, further comprising:
changing the resource policy;
updating the network policy enforcer responsive to the detection without changing any configuration of the pod;
updating the network policy enforcer responsive to the detection without changing any program code associated with the pod; and
updating the network policy enforcer responsive to the detection without introducing a down time for the pod.

14. A system comprising:
a plurality of microservice pods to share a resource, wherein:
the plurality of microservice pods comprises a first microservice pod comprising a first container corresponding to a microservice and a second container; and
the second container to regulate network traffic with the first container based on a consumer policy associated with a consumption quota for the microservice; and
a shared service pod comprising a third container corresponding to a resource shared by the plurality of microservice pods and a fourth container to provide a second proxy, wherein the second proxy to regulate network traffic with the third container based on a resource policy associated with a capacity quota for the resource.

15. The system of claim 14, wherein the second container comprises a network traffic filter, and the system further comprises:
a network enforcer external to the first microservice pod, wherein the network enforcer to:
receive a request from the second container associated with a consumption of the resource by the microservice; and
selectively approve the request based on a cumulative usage of the microservice and the consumer policy.

16. The system of claim 15, wherein the network enforcer to selectively approve the request based on a rule set corresponding to the consumer policy, the system further comprising:
a policy repository to store data representing the consumer policy, wherein the network enforcer to monitor the policy repository for a modification to the consumer policy, and the network enforcer to update the rule set response to the consumer policy being modified.

17. The system of claim 16, wherein the data represents at least one of the rule set, program instructions or the consumption quota.

18. A non-transitory storage medium that stores machine-readable instructions that, when executed by a machine, cause the machine to:
monitor transport layer traffic associated with a cumulative usage of a resource by a first microservice consumer, wherein the resource is shared by a plurality of microservice consumers including the first microservice consumer;
receive, by a proxy for the first microservice consumer, a request associated with the first microservice consumer using the resource; and
selectively permit the request based on the cumulative usage and a policy defining a consumption quota for the first microservice.

19. The storage medium of claim 18, wherein the instructions, when executed by the machine, further cause the machine to:
monitor transport layer traffic associated with a cumulative usage of the resource by the plurality of microservice consumers;
receive, by a proxy for the resource, a second request initiated responsive to the first request and associated with the usage of the resource; and
selectively permit the second request based on the cumulative usage of the resource and a policy defining a capacity of the resource.

20. The storage medium of claim 18, wherein the consumption quota comprises at least one of a number of open network connections for the first microservice consumer, an ingress data per unit of time received by the first microservice, or an egress data per unit of time provided by the first microservice.
